(19) United States
(12) Patent Application Publication
(10) Pub. No.: US 2010/0280877 A1
(43) Pub. Date: Nov. 4, 2010

(54) TECHNIQUES FOR PRODUCT AFFINITY ANALYSIS

(76) Inventors: Scott Shelton, Apex, NC (US); Henry Fu, Chapel Hill, NC (US); Michael Chaves, Cary, NC (US); Leslie Mannion, Cary, NC (US); Rajeswara Kottu, Cary, NC (US); Robert Baril, Apex, NC (US)

Correspondence Address: JAMES M. STOVER;TERADATA CORPORATION, 2835 MIAMI VILLAGE DRIVE, MIAMISBURG, OH, 45342, US

(21) Appl. No.: 12/433,493

(22) Filed: Apr. 30, 2009

(51) Int. Cl. G06Q 10/00; G06F 3/048; G06F 17/30

(52) U.S. Cl. 705/10; 715/780; 707/E17.017; 707/E17.048

(57) ABSTRACT

Techniques for Product Affinity Analysis are presented. A user interacts with a tool to supply user-defined criteria. The criteria are used to automatically generate code that processes against a data store to collect results that conform to conditions defined by the criteria. The results are used to automatically populate a Product Affinity Analysis chart or grid for the user to view and in some cases dynamically interact with.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example screen shots and images as described below and in any drawings hereto: Copyright © 2009, Teradata, Inc. of Miamisburg, Ohio—All Rights Reserved.

### BACKGROUND

Enterprises are increasingly capturing, storing, and mining a plethora of information related to communications with their customers. Often this information is stored and indexed within databases. Once the information is indexed, queries are developed on an as-needed basis to mine the information from the database for a variety of organizational goals.

Product Affinity Analysis is an important tool that marketing managers use to understand a variety of purchase or use patterns with their customers. Product Affinity Analysis enables one to create bar charts or grids showing how many customers bought a specific product or service, how much the customers spent on each product, and which related products the customers bought.

Conventionally, Product Affinity Analysis is limited to analyzing only a predefined set of measures which are usually hard-coded by support personnel in Structured Query Language (SQL). This makes it very difficult for an enterprise to create a chart based on any measures other than the predefined set.

Additionally, typical Product Affinity Analysis charts use customers vs. products or transactions vs. products comparisons. Generally, Product Affinity Analysis products cannot do calculations based on many-to-many relationships, nor can they plot products vs. stores to gauge store inventory or ascertain hotel preferences for travel customers.

Finally, conventional Product Affinity Analysis products force users to re-enter all of their criteria when they want to create a new chart.

Thus, it can be seen that improved techniques for Product Affinity Analysis are desirable.

### SUMMARY

In various embodiments, techniques for Product Affinity Analysis are presented. According to an embodiment, a method for Product Affinity Analysis is presented. Specifically, a user is interacted with for gathering criteria for a Product Affinity Analysis chart. Next, the criteria are recorded for current use in generating the Product Affinity Analysis chart and for future use in subsequently generating the Product Affinity Analysis chart or derivations thereof. Finally, Structured Query Language (SQL) code is dynamically and automatically generated. The code when processed against a data store produces results to populate the Product Affinity Analysis chart.

### BRIEF DESCRIPTION OF THE DRAWINGS

FIG. 1 is a diagram of a method for Product Affinity Analysis, according to an example embodiment.

FIG. 2 is a diagram of another method for Product Affinity Analysis, according to an example embodiment.

FIG. 3 is a diagram of a Product Affinity Analysis system, according to an example embodiment.

### DETAILED DESCRIPTION

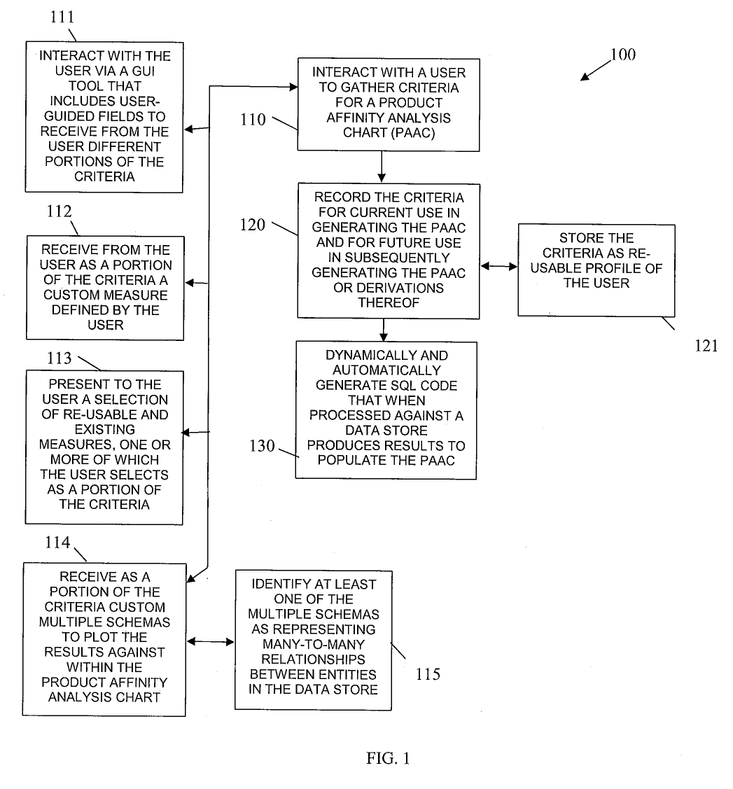

FIG. 1 is a diagram of a method 100 for Product Affinity Analysis, according to an example embodiment. The method 100 (hereinafter “affinity analysis service”) is implemented in a machine-accessible or computer-readable storage medium as instructions that is executed by a machine (processing device (processor-enabled with memory) performs the processing depicted in FIG. 1. Moreover, the affinity analysis service is optionally accessible over a network. The network may be wired, wireless, or a combination of wired and wireless.

A “data store” as used herein may include a database, a collection of databases organized as a data warehouse, a directory, a collection of directories cooperating with one another, or various combinations of the same. According to an embodiment, the data store is a Teradata® warehouse product or service distributed by Teradata, Inc. of Miamisburg, Ohio.

The data store includes a variety of enterprise information. One type of information is referred to as an “entity.” An entity is something that can be uniquely identified (e.g., a customer account, a customer name, a household name, a logical grouping of certain types of customers, etc.).

A table within the data store may include a schema that defines the relationship between one or more elements in the data store. For example, the relationship between data store element “household” to element “individual” and to element “account” (household→individual→account). The schema defines the fields or elements of the data store. The data store includes a plurality of different tables and different schema's. Schema relationships may be hierarchical or many-to-many relationships.

“Segmentation” refers to relationships that are defined for a particular population that may be the target of a communication sent from an enterprise. For example, a segment may define all males over the age of 18 in the Raleigh, N.C. area. Segments can be predefined within the data store or can be dynamically defined and acquired via queries against the data store. “Cross Segment” refers to analyzing measures at the intersections of multiple different segments.

An “analysis module” refers to a data store application that is designed to perform one or more queries and/or other operations on data acquired from the data store. The analysis module may be directed to achieve some form of desired analysis by an enterprise. Some example analysis types include, but are not limited to, behavior trend analysis, cross segment analysis, pattern detection, percentile profiling, product or service affinity analysis, and the like.

A “measure” is a calculation or set of calculations performed against data returned from the data store. “Measures,” as used herein, may be pre-existing within an Application Programming Interface (API) of the data store or may be user-defined. An example measure may be to take the average purchase amount from a given set of data associated with customers. Measures can be simple or complex and involve multiple operations some of which rely on prior processed operations. One or more measures are referenced or used within any given analysis module.

It is within this context that the processing associated with the affinity analysis service is now described in detail with reference to the FIG. 1.

At 110, the affinity analysis service interacts with a user to gather criteria for a Product Affinity Analysis chart or grid. The criteria include an analysis type, attributes, schema(s), and measures. The criteria can be gathered and include a variety of conditions that are used to produce SQL (described below at 130) and populate a user-defined Product Affinity Analysis Chart or Grid.

For example, at 111, the affinity analysis service interacts with the user via a Graphical User Interface (GUI) Tool that includes user-guided fields to receive from the user different portions of the criteria. So, one or more GUI screens have fields for receiving different portions of the criteria (analysis type, attributes, schema(s), and measures).

In another case, at 112, the affinity analysis service receives from the user a portion of the criteria and that portion is a custom measure. The custom measure is a user-defined and reusable aggregate calculation, such as “Average Purchase Amount,” “Number of customers who bought a particular product,” “Total Items Sold,” etc.

In yet another situation, at 113, the affinity analysis service presents to the user a selection of re-usable and existing measures, one or more of which the user selects as a portion of the criteria. So, a fixed list of predefined measures can be selected via a toolbar on a GUI and displayed to the user and from which the user selects one or more of the existing measures as a portion of the criteria.

According to an embodiment, at 114, the affinity analysis service receives as a portion of the criteria custom multiple schemas to plot the results against within the Product Affinity Analysis chart or grid.

Continuing with the embodiment at 114 and at 115, the affinity analysis service identifies at least one of the multiple schemas as representing many-to-many relationships between entities in the data store.

At 120, the affinity analysis service records the criteria for current use in generating the Product Affinity Analysis chart and also for future use in subsequently generating the Product Affinity Analysis chart or derivations thereof.

In an embodiment, at 121, the affinity analysis service stores the criteria as a re-usable profile of the user.

At 130, the affinity analysis service dynamically and automatically generate SQL code that when processed against a data store, such as an enterprise data warehouse, produces results to populate the Product Affinity Analysis chart or grid.

Once the SQL code is generated, instances of the Product Affinity Analysis chart or grid can be produced when the SQL code is processed against the data store. The result grid, in some embodiments, is interactive permitting the user to drill down or up within the results to view different levels of details. Some data can also be highlighted or selected by the user from the chart and used as a segment for further analysis.

It is also noted that in some embodiments the results can be displayed via other structures or display views other than just a chart or a grid.

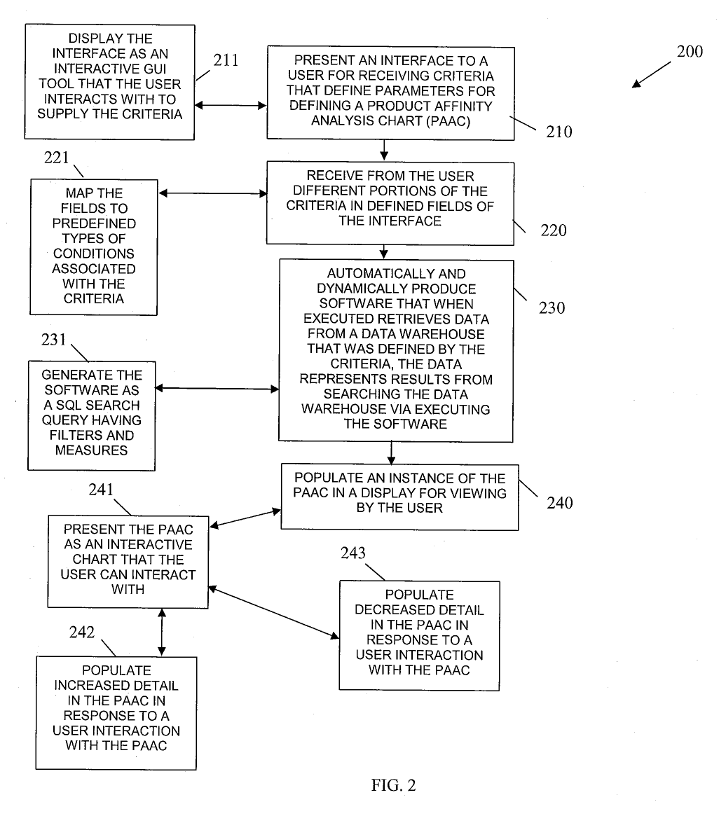

FIG. 2 is a diagram of another method 200 for product affinity analysis, according to an example embodiment. The method 200 (hereinafter “product affinity service”) is implemented in a machine-accessible or a computer-readable storage medium as instructions that are executed by a machine (processor) and perform the processing reflected in FIG. 2. The product affinity service may also be accessible over a network. The network may be wired, wireless, or a combination of wired and wireless.

The product affinity service presents an alternative and in some cases an enhanced processing perspective to the affinity analysis service represented by the method 100 of the FIG. 1.

At 210, the product affinity service presents an interface to a user for receiving criteria that define parameters for defining a Product Affinity Analysis chart. That is, the parameters define conditions that when generated as software (described below with respect to the processing at 230) retrieves data from a data store for purposes of populating an instance of the Product Affinity Analysis chart.

According to an embodiment, at 211, the product affinity service displays the interface as an interactive GUI tool that the user interacts with to supply the criteria. So, the GUI tool includes labels, input fields, pull down menus for guiding the user to supply the criteria.

At 221, the product affinity service maps fields to predefined types or conditions associated with the criteria. In other words, the product affinity service can identify what types of conditions are being entered by which field the user enters or selects for a particular portion of the criteria. This is structured way to interact with the user and acquire the criteria in a manner that permits it to be automatically processed by the processor via the product affinity service.

At 230, the product affinity service automatically, dynamically, and in real-time produces software instructions or code. That software when executed on the processor retrieves data from a data warehouse. The data is defined by the criteria and represents results from searching the data warehouse when executing the software.

In an embodiment, at 231, the product affinity service generates the software as a SQL search query having filers and measures defined in criteria.

At 240, the product affinity service populates an instance of the Product Affinity Analysis chart in a display for viewing by the user.

According to an embodiment, at 241, the product affinity service presents the Product Affinity Analysis chart as an interactive chart on the display that the user can interact with via an input device interfaced to the processor, such as a mouse or other pointing or selection device. In some cases, the display may be a touch screen, such that a finger touch can be used as the input mechanism and the input device is viewed as the touch screen.

Continuing with the embodiment at 241 and at 242, the product affinity service populates increased detail in the Product Affinity Analysis chart in response to a user interaction with the Product Affinity Analysis chart.

Also continuing with the embodiment at 241 and at 243, the product affinity service populates decreased detail in the Product Affinity Analysis chart in response to a user interaction with the Product Affinity Analysis chart.

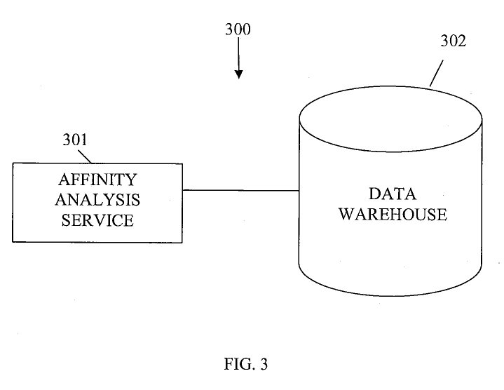

FIG. 3 is a diagram of a Product Affinity Analysis system 300, according to an example embodiment. The Product Affinity Analysis system 300 is implemented in a machine-accessible and/or computer-readable storage medium that is executed by one or more processors and is operational over a network. The network may be wired, wireless, or a combination of wired and wireless.

In an embodiment, portions of the Product Affinity Analysis system 300 implements, among other things the affinity analysis service and the product affinity service represented by the methods 100 and 200 of the FIGS. 1 and 2, respectively.

The Product Affinity Analysis system 300 includes an affinity analysis service 301 and a data warehouse 302. Each of these and their interactions with one another will now be discussed in turn.

The affinity analysis service 301 is implemented in a computer-readable storage medium and executes on a processor. That is the processor is configured to execute the affinity analysis service 301. Example processing associated with the affinity analysis service 301 was presented above in detail with reference to the methods 100 and 200 of the FIGS. 1 and 2, respectively.

The affinity analysis service 301 dynamically interacts with a user to gather user-defined criteria. The user-defined criteria are then used to dynamically and automatically generate SQL code. The SQL code when processed against the data warehouse 302 produces a user-defined Product Affinity Analysis chart or grid.

In an embodiment, the Product Affinity Analysis chart or grid is interactive, such that the user can drill down or drill up in details associated with results that populate the Product Affinity Analysis chart.

According to an embodiment, the user is a business analyst that is not a developer or a programmer.

In another situation, the affinity analysis service 301 presents a GUI tool to the user for supplying the user-defined criteria. The GUI tool includes predefined fields for receiving predefined types of conditions associated with the user-defined criteria.

In another case, the affinity analysis service 301 saves the user-defined criteria as a profile for the user to re-use.

The data warehouse 302 is implemented in a computer-readable storage medium as a storage device that is accessed by the processor via the affinity analysis service 301. Some example aspects of the data warehouse 302 were presented above with reference to the methods 100 and 200 of the FIGS. 1 and 2, respectively.

According to an embodiment, the data warehouse is a collection of relational databases interfaced together. Now some example source code that can be generated by portions of the techniques presented herein and that can be used to implemented portions of the techniques presented herein are presented. An example set of SQL that can be generated based on some arbitrary user inputs may appear as follows:

```
SELECT
  TRIM(BOTH FROM p.CATEGORY_DESC) desc_code,
  TRIM(BOTH FROM p.CATEGORY_DESC) desc_value,
  t.CATEGORY_CD LEVEL0,
  t.tot_dollars,
  t.tot_items,
  t.tot_customers,
  t.AVG_TRANS_SPEND_PRODUCT,
  t.MAX_ITEM_QTY2
  from
  (
  select
  t.CATEGORY_CD,
  sum(t.tot_items) tot_items,
  sum(t.tot_dollars) tot_dollars,
  sum(t.tot_customers) tot_customers,
  AVG(PURCHASE_AMT / GROSS_PURCHASE_AMT)
  AVG_TRANS_SPEND_PRODUCT,
  MAX(ITEM_QTY) MAX_ITEM_QTY2
  from
  (
  SELECT
  “HOUSEHOLD_ACTIVITY_SUMMARY”.“HOUSEHOLD_ID”
  FROM
  “CUSTDATA”.“HOUSEHOLD_ACTIVITY_SUMMARY”
  “HOUSEHOLD_ACTIVITY_SUMMARY”
  WHERE
  (
  “HOUSEHOLD_ACTIVITY_SUMMARY”.“HOUSEHOLD_ID”
  ) IN
  (
  SELECT
    “INDIVIDUAL_DEMOGRAPHICS”.“HOUSEHOLD_ID”
  FROM
    “CUSTDATA”.“INDIVIDUAL_DEMOGRAPHICS”
  “INDIVIDUAL_DEMOGRAPHICS”
  JOIN
    “CUSTDATA”.“STORE” “STORE”
  ON
    (“INDIVIDUAL_DEMOGRAPHICS”.“PREFERRED_STORE_ID”
  = “STORE”.“STORE_ID”)
  WHERE
    (“STORE”.“REGION_ID” = 1)
  )
  ) seg
  JOIN
  (
  SELECT
  “TRANS”.“HOUSEHOLD_ID”,
  “TRANS”.“CATEGORY_CD”
  FROM
  TempTable
  GROUP BY
  “TRANS”.“HOUSEHOLD_ID”,
  “TRANS”.“CATEGORY_CD”
  ) t
  ON
  (seg.HOUSEHOLD_ID = t.HOUSEHOLD_ID)
  LEFT OUTER JOIN
  (
  SELECT
  “TRANS”.“HOUSEHOLD_ID”,
  “TRANS”.“CATEGORY_CD”,
  Count(Distinct trim(“TRANS”.“HOUSEHOLD_ID”) || ‘-’||
  trim(“TRANS”.“CATEGORY_CD”)) tot_customers,
  Sum(“TRANS”.“ITEM_QTY”) tot_items,
  SUM(“TRANS”.“PURCHASE_AMT”) tot_dollars,
  MAX(“TRANS”.“ITEM_QTY”) MAX_ITEM_QTY2
  FROM
  “CUSTDATA”.“TRANS” “TRANS”
  WHERE
  (<Complete Joins>) IN
  (
  SELECT
  <Complete Joins>
  FROM
    TempTable // temp table from step 0 above.
  )
  GROUP BY
  “TRANS”.“HOUSEHOLD_ID”,
  “TRANS”.“CATEGORY_CD”
  ) measure
  ON
  (
  t.HOUSEHOLD_ID = measure.HOUSEHOLD_ID and
  t.CATEGORY_CD = measure.CATEGORY_CD
  )
  LEFT OUTER JOIN
  (
  SELECT
  “TRANS”.“HOUSEHOLD_ID”,
  “TRANS”.“CATEGORY_CD”,
  AVG(“TRANS”.“PURCHASE_AMT” /
  “YEAR_HH_X_DEPT_SUMMARY”.
  “GROSS_PURCHASE_AMT”)
  AVG_TRANS_SPEND_PRODUCT
  FROM
  “CUSTDATA”.“YEAR_HH_X_DEPT_SUMMARY”
  “YEAR_HH_X_DEPT_SUMMARY”
  JOIN
  “CUSTDATA”.“TRANS” “TRANS”
  ON
  (“YEAR_HH_X_DEPT_SUMMARY”.“HOUSEHOLD_ID” =
  “TRANS”.“HOUSEHOLD_ID”) AND
  (“YEAR_HH_X_DEPT_SUMMARY”.“CATEGORY_CD” =
  “TRANS”.“CATEGORY_CD”) AND
  (“YEAR_HH_X_DEPT_SUMMARY”.“GROUP_CD” =
  “TRANS”.“GROUP_CD”) AND
  (“YEAR_HH_X_DEPT_SUMMARY”.“DEPT_ID” =
  “TRANS”.“DEPT_ID”) and
  (“YEAR_HH_X_DEPT_SUMMARY”.“YEAR_START_DT” <=
  “TRANS”.“PURCHASE_DT”) and
  (“YEAR_HH_X_DEPT_SUMMARY”.
  “LAST_PURCHASE_DT” >=“TRANS”.“PURCHASE_DT”)
  WHERE
  (“YEAR_HH_X_DEPT_SUMMARY”.
  10) “GROSS_PURCHASE_AMT” >= and
  (“TRANS”.“PURCHASE_DT” between ‘04/01/1996’ (date, format
  ‘MM/DD/YYYY’) and
        ‘06/30/1996’ (date, format ‘MM/DD/YYYY’))
  and
  (<Complete Joins>) IN
  (
  SELECT
    <Complete Joins>
  FROM
    TempTable
  WHERE
    TempTable.purchase_dt between
  “YEAR_HH_X_DEPT_SUMMARY”.“YEAR_START_DT” and
  “YEAR_HH_X_DEPT_SUMMARY”.“LAST_PURCHASE_DT”
  )
  GROUP BY
  “TRANS”.“HOUSEHOLD_ID”,
  “TRANS”.“CATEGORY_CD”
  ) measure_multitable_1
  ON
  (
  t.HOUSEHOLD_ID = measure_multitable_1.HOUSEHOLD_ID and
  t.CATEGORY_CD = measure_multitable_1.CATEGORY_CD
  )
  group by
  t.CATEGORY_CD
  ) t
  JOIN
  CUSTDATA.CATEGORY p
  ON
  t.CATEGORY_CD = p.CATEGORY_CD
        ©Teradata, Inc. 2009
```

Some example source SQL to generate portions of the techniques presented herein may appear as follows:

Query Form: Product Affinity Analysis SQL

This query form file has 6 sections:

0) create temporary table for the main table of the Analysis

1) Product Affinity Analysis, regular

2) Product Affinity Analysis, regular affinity

3) Product Affinity Analysis, time chart

4) Product Affinity Analysis, regular, targeting

5) Product Affinity Analysis, regular affinity, targeting

Within each section, there is a query form and an example SQL.

0) Create Temporary Table for the Main Table of the Analysis

```
CREATE
  TempTable
AS
  (
  SELECT
  *
  FROM
  <main table>
  WHERE
  <filters>
  <date ranges>
  [<not affinity product selections>] // only applies when doing
affinity; not present otherwise
  )
WITH DATA;
```

example SQL:

```
SELECT
  *
FROM
  “CUSTDATA”.“TRANS” “TRANS”
WHERE
  (“TRANS”.“PURCHASE_AMT” >= 5) AND  //
filter of the analysis
  (“TRANS”.“PURCHASE_DT” BETWEEN ‘01/01/1996’ (DATE,
FORMAT ‘MM/DD/YYYY’) AND  // date range of the analysis
                ‘12/31/1997’ (DATE, FORMAT ‘MM/DD/YYYY’))
  AND NOT (“TRANS”.“CATEGORY_CD”) IN  // not
include product(s) affinitied on
  (
  SELECT
  “CATEGORY”.“CATEGORY_CD”
  FROM
  “CUSTDATA”.“CATEGORY” “CATEGORY”
  WHERE
  (“CATEGORY”.“CATEGORY_CD” = ‘ACC’)
  )
```

1) Product Affinity Analysis, Regular

Query Form:

| | |
|---|---|
| SELECT | |
| <Column>, ... | // product related columns |
| <Column>, ... | // measures |
| FROM | |
| ( | |
| SELECT | |
| <Semantic Key>, ... | // product level |

```
  <Aggregate Formula Column>, ...  // measures
  FROM
```

| | |
|---|---|
| [<Table>] | // sub-select. this is the sub-select for the |
| segment. optional. | |
| [JOIN] | |
| ( | |
| SELECT | |
| <Semantic Key>, ... | // semantic keys as specified in the profile |

(e.g., Category and Household).
FROM

| | |
|---|---|
| <Table> | // temp table from step 0 above. |
| GROUP BY | |
| <Semantic Key>, ... | // semantic keys as specified in the profile |

```
(e.g., Category and Household).
  ) main Table
  [
  ON
```

| | |
|---|---|
| <joins on semantic level> | // semantic level of the analysis, |

```
not the product level (e.g., Household only).
  ]
  [
  LEFT OUTER JOIN
  (
  SELECT
```

| | |
|---|---|
| <Semantic Key>, ... | // semantic keys as specified in the |

```
profile (e.g., Category and Household).
    <Aggregate Formula Column>, ...  // intermediate values for
    measures.
  FROM
```

| | |
|---|---|
| <Table>, ... | // table(s) where this measure is sourced from |
| (measure table). | |
| WHERE | |
| <Condition>, ... | // condition(s) such as date range and/or filter |
| of the measure. | |
| (<Complete Joins>) | |
| IN | |
| ( | |
| SELECT | |
| <Complete Joins> | |
| FROM | |
| <Table> | // temp table from step 0 above. |
| [ | |
| JOIN | |
| <Table>, ... | // link table(s) that are needed for the join |

```
between measure table and temp table.
    ON
    <Joins>
    ]
    [
    WHERE
```

| | |
|---|---|
| <Non-Equi Joins> | // non-equi joins to complete the join |

```
between measure table and temp/link table.
    ]
    )
  GROUP BY
```

| | |
|---|---|
| <Semantic Key>, ... | // semantic keys as specified in the profile |

```
(e.g., Category and Household).
  ) measure1
  ON
```

| | |
|---|---|
| <joins on semantic level> | // semantic level of the |

analysis, AND the product level (e.g., Household and Category).

| | |
|---|---|
| ], ... | // can have multiple measure sub-selects just |
| like the above. | |
| GROUP BY | |

| | |
|---|---|
| <Semantic Key>, ... | // product level |
| ) | |
| JOIN | |
| <Table> | // customer table with information about |
| products | |
| ON | |
| <Semantic Key>, ... | // product level |

Example sql:

```
select
  TRIM(BOTH FROM p.CATEGORY_DESC) desc_code,
  TRIM(BOTH FROM p.CATEGORY_DESC) desc_value,
  t.CATEGORY_CD LEVEL0,
  t.tot_dollars,
  t.tot_items,
  t.tot_customers,
  t.AVG_TRANS_SPEND_PRODUCT,
  t.MAX_ITEM_QTY2
from
  (
  select
  t.CATEGORY_CD,
  sum(t.tot_items) tot_items,
  sum(t.tot_dollars) tot_dollars,
  sum(t.tot_customers) tot_customers,
  AVG(PURCHASE_AMT / GROSS_PURCHASE_AMT)
AVG_TRANS_SPEND_PRODUCT,
  MAX(ITEM_QTY)  MAX_ITEM_QTY2
  from
  (
  SELECT
    “HOUSEHOLD_ACTIVITY_SUMMARY”.“HOUSEHOLD_ID”
  FROM
    “CUSTDATA”.“HOUSEHOLD_ACTIVITY_SUMMARY”
“HOUSEHOLD_ACTIVITY_SUMMARY”
  WHERE
    (
    “HOUSEHOLD_ACTIVITY_SUMMARY”.“HOUSEHOLD_ID”
    ) IN
    (
    SELECT
    “INDIVIDUAL_DEMOGRAPHICS”.“HOUSEHOLD_ID”
    FROM
    “CUSTDATA”.“INDIVIDUAL_DEMOGRAPHICS”
“INDIVIDUAL_DEMOGRAPHICS”
    JOIN
    “CUSTDATA”.“STORE” “STORE”
    ON
    (“INDIVIDUAL_DEMOGRAPHICS”.“PREFERRED_STORE_ID” =
“STORE”.“STORE_ID”)
    WHERE
    (“STORE”.“REGION_ID” = 1)
    )
  ) seg
  JOIN
  (
  SELECT
    “TRANS”.“HOUSEHOLD_ID”
    “TRANS”.“CATEGORY_CD”
  FROM
    TempTable  // temp table from step 0 above.
  GROUP BY
    “TRANS”.“HOUSEHOLD_ID”,
    “TRANS”.“CATEGORY_CD”
  ) t
  ON
  (seg.HOUSEHOLD_ID = t.HOUSEHOLD_ID)
  LEFT OUTER JOIN
  (
  SELECT
    “TRANS”.“HOUSEHOLD_ID”,
    “TRANS”.“CATEGORY_CD”,
    Count(Distinct trim(“TRANS”.“HOUSEHOLD_ID”) || ‘-’||
trim(“TRANS ”.“CATEGORY_CD”)) tot_customers,
    Sum(“TRANS”.“ITEM_QTY”) tot_items,
    SUM(“TRANS”.“PURCHASE_AMT”) tot_dollars,
    MAX(“TRANS”.“ITEM_QTY”) MAX_ITEM_QTY2
  FROM
    “CUSTDATA”.“TRANS” “TRANS”
  WHERE
    (<Complete Joins>) IN
    (
    SELECT
    <Complete Joins>
    FROM
    TempTable  // temp table from step 0 above.
    )
  GROUP BY
    “TRANS”.“HOUSEHOLD_ID”,
    “TRANS”.“CATEGORY_CD”
  ) measure
  ON
  (
  t.HOUSEHOLD_ID = measure.HOUSEHOLD_ID and
  t.CATEGORY_CD = measure.CATEGORY_CD
  )
  LEFT OUTER JOIN
  (
  SELECT
    “TRANS”.“HOUSEHOLD_ID”,
    “TRANS”.“CATEGORY_CD”,
    AVG(“TRANS”.“PURCHASE_AMT ”/
“YEAR_HH_X_DEPT_SUMMARY”.“GROSS_PURCHASE_AMT”)
AVG_TRANS_SPEND_PRODUCT
  FROM
    “CUSTDATA”.“YEAR_HH_X_DEPT_SUMMARY”
“YEAR_HH_X_DEPT_SUMMARY”
  JOIN
    “CUSTDATA”.“TRANS” “TRANS”
  ON
    (“YEAR_HH_X_DEPT_SUMMARY”.“HOUSEHOLD_ID” =
“TRANS”.“HOUSEHOLD_ID”) AND
    (“YEAR_HH_X_DEPT_SUMMARY”.“CATEGORY_CD” =
“TRANS”.“CATEGORY_CD”) AND
    (“YEAR_HH_X_DEPT_SUMMARY”.“GROUP_CD” =
“TRANS”.“GROUP_CD”) AND
    (“YEAR_HH_X_DEPT_SUMMARY”.“DEPT_ID” = “TRANS”.“DEPT_ID”)
and
    (“YEAR_HH_X_DEPT_SUMMARY”.“YEAR_START_DT” <=
“TRANS”.“PURCHASE_DT”) and
    (“YEAR_HH_X_DEPT_SUMMARY”.“LAST_PURCHASE_DT” >=
“TRANS”.“PURCHASE_DT”)
  WHERE
    (“YEAR_HH_X_DEPT_SUMMARY”.“GROSS_PURCHASE_AMT” >=
10) and
    (“TRANS”.“PURCHASE_DT” between ‘04/01/1996’ (date, format
‘MM/DD/YYYY’) and
                        ‘06/30/1996’ (date, format ‘MM/DD/YYYY’)) and
    (<Complete Joins>) IN
    (
    SELECT
    <Complete Joins>
    FROM
    TempTable  // temp table from step 0 above.
    WHERE
    TempTable.purchase_dt between
“YEAR_HH_X_DEPT_SUMMARY”.“YEAR_START_DT” and
“YEAR_HH_X_DEPT_SUMMARY”.“LAST_PURCHASE_DT”
    )
  GROUP BY
    “TRANS”.“HOUSEHOLD_ID”,
    “TRANS”.“CATEGORY_CD”
  ) measure_multitable_1
  ON
  (
  t.HOUSEHOLD_ID = measure_multitable_1.HOUSEHOLD_ID and
  t.CATEGORY_CD = measure_multitable_1.CATEGORY_CD
  )
  group by
  t.CATEGORY_CD
  ) t
JOIN
  CUSTDATA.CATEGORY p
ON
  t.CATEGORY_CD = p.CATEGORY_CD
```

2) Product Affinity Analysis, Regular Affinity

Query Form:

```
SELECT
  <Column>, ...  // product related columns
  <Column>, ...  // measures
FROM
  (
  SELECT
  <Semantic Key>, ...  // product level
  <Aggregate Formula Column>, ...  // measures
  FROM
  [<Table>] // sub-select. this is the sub-select for the
segment. optional.
  [JOIN]
  (
  SELECT
    DISTINCT <Semantic Key>, ...  // semantic level of the analysis, not
the product level (e.g., Household only).
  FROM
    <Table> // main table of the analysis
  WHERE
    <Condition>, ...  // condition(s) such as date range and/or filter
of the analysis.
    <affinity product selections> // product(s) affinitied on
  )
  [
  ON
  <joins on semantic level> // semantic level of the analysis, not the
product level (e.g., Household only).
  ]
  JOIN
  (
  SELECT
    <Semantic Key>, ...  // semantic keys as specified in the profile
(e.g., Category and Household).
  FROM
    <Table> // temp table from step 0 above.
  GROUP BY
    <Semantic Key>, ...  // semantic keys as specified in the profile
(e.g., Category and Household).
  ) mainTable
  ON
  <joins on semantic level> // semantic level of the analysis, not the
product level (e.g., Household only).
  [
  LEFT OUTER JOIN
  (
  SELECT
    <Semantic Key>, ...  // semantic keys as specified in the profile
(e.g., Category and Household).
    <Aggregate Formula Column>, ...  // intermediate values for measures.
  FROM
    <Table>, ...  // table(s) where this measure is sourced from
(measure table).
  WHERE
    <Condition>, ...  // condition(s) such as date range and/or filter
of the measure.
    (<Complete Joins>) IN
    (
    SELECT
    <Complete Joins>
    FROM
    <Table> // temp table from step 0 above.
    [
    JOIN
    <Table>, ...  // link table(s) that are needed for the join
between measure table and temp table.
    ON
    <Joins>
    ]
    [
    WHERE
    <Non-Equi Joins> // non-equi joins to complete the join
between measure table and temp/link table.
    ]
    )
  GROUP BY
    <Semantic Key>, ...  // semantic keys as specified in the profile
(e.g., Category and Household).
  ) measure1
  ON
  <joins on semantic level> // semantic level of the analysis, AND the
product level (e.g., Household and Category).
  ], ...  // can have multiple measure sub-selects just like
the above.
  GROUP BY
  <Semantic key>, ...  // product level
  )
JOIN
  <Table> // customer table with information about
products
ON
  <Semantic Key>, ...  // product level
```

Example sql:

```
select
  TRIM(BOTH FROM p.CATEGORY_DESC) desc_code,
  TRIM(BOTH FROM p.CATEGORY_DESC) desc_value,
  t.CATEGORY_CD LEVEL0,
  t.tot_dollars,
  t.tot_items,
  t.tot_customers,
  t.AVG_TRANS_SPEND_PRODUCT,
  t.MAX_ITEM_QTY2
from
  (
  select
  t.CATEGORY_CD,
  sum(t.tot_items) tot_items,
  sum(t.tot_dollars) tot_dollars,
  sum(t.tot_customers) tot_customers,
  AVG(PURCHASE_AMT/GROSS_PURCHASE_AMT)
AVG_TRANS_SPEND_PRODUCT,
  MAX(ITEM_QTY)  MAX_ITEM_QTY2
  from
  (
  SELECT
    “HOUSEHOLD_ACTIVITY_SUMMARY”.“HOUSEHOLD_ID”
  FROM
    “CUSTDATA”.“HOUSEHOLD_ACTIVITY_SUMMARY”
“HOUSEHOLD_ACTIVITY_SUMMARY”
  WHERE
    (
    “HOUSEHOLD_ACTIVITY_SUMMARY”.“HOUSEHOLD_ID”
    ) IN
    (
    SELECT
    “INDIVIDUAL_DEMOGRAPHICS”.“HOUSEHOLD_ID”
    FROM
    “CUSTDATA”.“INDIVIDUAL_DEMOGRAPHICS”
“INDIVIDUAL_DEMOGRAPHICS”
    JOIN
    “CUSTDATA”.“STORE” “STORE”
    ON
    (“INDIVIDUAL_DEMOGRAPHICS”.“PREFERRED_STORE_ID” =
“STORE”.“STORE_ID”)
    WHERE
    (“STORE”.“REGION_ID” = 1)
    )
  ) seg
  JOIN
  (
  select
    Distinct t.HOUSEHOLD_ID
  from
    CUSTDATA.trans t
  where
    (t.PURCHASE_AMT >= 5) AND  // filter of the
analysis
    (t.PURCHASE_DT between ‘01/01/1996’ (date, format ‘MM/DD/YYYY’)
AND // date range of the analysis
                    ‘12/31/1997’ (date, format ‘MM/DD/YYYY’)) AND
    (“TRANS”.“CATEGORY_CD”) in  // product(s)
affinitied on
    (
    SELECT
    “CATEGORY”.“CATEGORY_CD”
    FROM
    “CUSTDATA”.“CATEGORY” “CATEGORY”
    WHERE
    (“CATEGORY”.“CATEGORY_CD” = ‘ACC’)
    )
  ) p
  ON
  (seg.HOUSEHOLD_ID = p.HOUSEHOLD_ID)
  JOIN
  (
  SELECT
    “TRANS”.“HOUSEHOLD_ID”,
    “TRANS”.“CATEGORY_CD”
  FROM
    TempTable  // temp table from step 0 above.
  GROUP BY
    “TRANS”.“HOUSEHOLD_ID”,
    “TRANS”.“CATEGORY_CD”
  ) t
  ON
  (
  seg.HOUSEHOLD_ID = t.HOUSEHOLD_ID and
  p.HOUSEHOLD_ID = t.HOUSEHOLD_ID
  )
  LEFT OUTER JOIN
  (
  SELECT
    “TRANS”.“HOUSEHOLD_ID”,
    “TRANS”.“CATEGORY_CD”,
    Count(Distinct trim(“TRANS”.“HOUSEHOLD_ID”) || ‘-’||
trim(“TRANS”.“CATEGORY_CD”)) tot_customers,
    Sum(“TRANS”.“ITEM_QTY”)  tot_items,
    SUM(“TRANS”.“PURCHASE_AMT”) tot_dollars,
    MAX(“TRANS”.“ITEM_QTY”)  MAX_ITEM_QTY2
  FROM
    “CUSTDATA”.“TRANS” “TRANS”
  WHERE
    (<Complete Joins>) IN
    (
    SELECT
    <Complete Joins>
    FROM
    Temp Table  // temp table from step 0 above.
    )
  GROUP BY
    “TRANS”.“HOUSEHOLD_ID”,
    “TRANS”.“CATEGORY_CD”
  ) measure
  ON
  (
  t.HOUSEHOLD_ID = measure.HOUSEHOLD_ID and
  t.CATEGORY_CD = measure.CATEGORY_CD
  )
  LEFT OUTER JOIN
  (
  SELECT
    “TRANS”.“HOUSEHOLD_ID”,
    “TRANS”.“CATEGORY_CD”,
    AVG(“TRANS”.“PURCHASE_AMT”/
“YEAR_HH_X_DEPT_SUMMARY”.“GROSS_PURCHASE_AMT”)
AVG_TRANS_SPEND_PRODUCT
  FROM
    “CUSTDATA”.“YEAR_HH_X_DEPT_SUMMARY”
“YEAR_HH_X_DEPT_SUMMARY”
  JOIN
    “CUSTDATA”.“TRANS” “TRANS”
  ON
    (“YEAR_HH_X_DEPT_SUMMARY”.“HOUSEHOLD_ID” =
“TRANS”.“HOUSEHOLD_ID”) AND
    (“YEAR_HH_X_DEPT_SUMMARY”.“CATEGORY_CD” =
“TRANS”.“CATEGORY_CD”) AND
    (“YEAR_HH_X_DEPT_SUMMARY”.“GROUP_CD” =
“TRANS”.“GROUP_CD”) AND
    (“YEAR_HH_X_DEPT_SUMMARY”.“DEPT_ID” = “TRANS”.“DEPT_ID”)
and
    (“YEAR_HH_X_DEPT_SUMMARY”.“YEAR_START_DT” <=
“TRANS”.“PURCHASE_DT”) and
    (“YEAR_HH_X_DEPT_SUMMARY”.“LAST_PURCHASE_DT” >=
“TRANS”.“PURCHASE_DT”)
  WHERE
    (“YEAR_HH_X_DEPT_SUMMARY”.“GROSS_PURCHASE_AMT” >=
10) and
    (“TRANS”.“PURCHASE_DT” between ‘04/01/1996’ (date, format
‘MM/DD/YYYY’) and
                        ‘06/30/1996’ (date, format ‘MM/DD/YYYY’)) and
    (<Complete Joins>) IN
    (
    SELECT
    <Complete Joins>
    FROM
    TempTable  // temp table from step 0 above.
    WHERE
    TempTable.purchase_dt between
“YEAR_HH_X_DEPT_SUMMARY”.“YEAR_START_DT” and
“YEAR_HH_X_DEPT_SUMMARY”.“LAST_PURCHASE_DT”
    )
  GROUP BY
    “TRANS”.“HOUSEHOLD_ID”,
    “TRANS”.“CATEGORY_CD”
  ) measure_multitable_1
  ON
  (
  t.HOUSEHOLD_ID = measure_multitable_1.HOUSEHOLD_ID and
  t.CATEGORY_CD = measure_multitable_1.CATEGORY_CD
  )
  group by
  t.CATEGORY_CD
  ) t
JOIN
  CUSTDATA.CATEGORY p
ON
  t.CATEGORY_CD = p.CATEGORY_C
```

3) Product Affinity Analysis, Time Chart

Query Form:

| | |
|---|---|
| SELECT | |
| <Column>, ... | // product and date related columns |
| <Column>, ... | // measures |
| FROM | |
| ( | |
| SELECT | |
| <Column>, ... | // period ID and description columns. |
| <Semantic Key>, ... | // product level |

```
  <Aggregate Formula Column>, ...  // measures
  FROM
  [<Table>] // sub-select. this is the sub-select
for the segment. optional.
  [JOIN]
  (
  SELECT
```

| | |
|---|---|
| <Semantic Key>, ... | // semantic keys as specified in the |

profile (e.g., Category and Household).

| | |
|---|---|
| <Column>, ... | // period ID and description columns. |
| FROM | |
| <Table> | // temp table from step 0 above. |
| <Table> | // period table. |
| WHERE | |
| <Condition>, ... | // condition(s) on the period table (e.g., |

```
division, frequency level).
    <Non-Equi Joins (complete)> // joins the period table to the
rest on the date usage code selected for the analysis.
                  // if this non-equi join is too slow, we can do a
period table with period_id and date
                  // as columns.
  GROUP BY
```

| | |
|---|---|
| <Semantic Key>, ... | // semantic keys as specified in the |

profile (e.g., Category and Household).

| | |
|---|---|
| <Column>, ... | // period ID and description columns. |
| ) main Table | |
| [ | |
| ON | |
| <joins on semantic level> | // semantic level of the analysis, |

```
not the product level (e.g., Household only).
  ]
  [
  LEFT OUTER JOIN
  (
  SELECT
```

| | |
|---|---|
| <Semantic Key>, ... | // semantic keys as specified in |

the profile (e.g., Category and Household).

| | |
|---|---|
| <Column>, ... | // period ID and description columns. |

```
    <Aggregate Formula Column>, ...  // intermediate values
    for measures.
  FROM
    (
    SELECT
```

| | |
|---|---|
| <Semantic Key>, ... | // semantic keys as specified in |

the profile (e.g., Category and Household).

| | |
|---|---|
| <Column>, ... | // columns for the dates. |
| <Column>, ... | // columns for the measures. |
| FROM | |

```
    <Table>, ...  // table(s) where this measure
is sourced from (measure table).
    WHERE
```

| | |
|---|---|
| [<Condition>, ...] | // condition(s) such as date range and/or |
| filter of the measure. | |

```
    (<Complete Joins>) IN
    (
    SELECT
      <Complete Joins>
    FROM
```

| | |
|---|---|
| <Table> | // temp table from step 0 above. |
| [ | |
| JOIN | |
| <Table>, ... | // link table(s) that are needed for the join |

```
between measure table and temp table.
    ON
      <Joins>
    ]
    [
    WHERE
```

| | |
|---|---|
| <Non-Equi Joins> | // non-equi joins to complete the join |

```
between measure table and temp/link table.
    ]
    )
    ) measure
```

| | |
|---|---|
| <Table> | // period table. |
| WHERE | |
| <Condition>, ... | // condition(s) on the period table (e.g., |

```
division, frequency level).
    <Non-Equi Joins (complete)> // joins the period table to the rest on
the date usage code selected for the analysis.
                  // if this non-equi join is too slow, we can do a
period table with period_id and date
                  // as columns.
  GROUP BY
```

| | |
|---|---|
| <Semantic Key>, ... | // semantic keys as specified in the profile |

(e.g., Category and Household).

| | |
|---|---|
| <Column>, ... | // period ID and description columns. |
| ) measure1 | |
| ON | |
| <joins on semantic level> | // semantic level of the analysis, |

AND the product level (e.g., Household and Category).

| | |
|---|---|
| <joins on date column> | // period ID and description columns. |

```
  ], ...  // can have multiple measure sub-selects just like
the above.
  GROUP BY
```

| | |
|---|---|
| <Column>, ... | // period ID and description columns. |
| <Semantic Key>, ... | // product level |
| ) | |
| JOIN | |
| <Table> | // customer table with information about |
| products | |
| ON | |
| <Semantic Key>, ... | // product level |

Example sql:

```
select
  t.dateday,
  t.datedesc,
  TRIM(BOTH FROM p.CATEGORY_DESC) desc_code,
  TRIM(BOTH FROM p.CATEGORY_DESC) desc_value,
  t.CATEGORY_CD LEVEL0,
  t.tot_dollars,
  t.tot_items,
  t.tot_customers,
  t.AVG_TRANS_SPEND_PRODUCT,
  t.MAX_ITEM_QTY2
from
  (
  select
  t.st_dt dateday,
  t.dt_desc datedesc,
  t.CATEGORY_CD,
  sum(measure.tot_items) tot_items,
  sum(measure.tot_dollars) tot_dollars,
  sum(measure.tot_customers) tot_customers,
  AVG(measure_multitable_1.AVG_TRANS_SPEND_PRODUCT)
AVG_TRANS_SPEND_PRODUCT,
  MAX(measure.MAX_ITEM_QTY2)  MAX_ITEM_QTY2
  from
  (
  SELECT
    “HOUSEHOLD_ACTIVITY_SUMMARY”.“HOUSEHOLD_ID”
  FROM
    “CUSTDATA”.“HOUSEHOLD_ACTIVITY_SUMMARY”
“HOUSEHOLD_ACTIVITY_SUMMARY”
  WHERE
    (
    “HOUSEHOLD_ACTIVITY_SUMMARY”.“HOUSEHOLD_ID”
    ) IN
    (
    SELECT
    “INDIVIDUAL_DEMOGRAPHICS”.“HOUSEHOLD_ID”
    FROM
    “CUSTDATA”.“INDIVIDUAL_DEMOGRAPHICS”
“INDIVIDUAL_DEMOGRAPHICS”
    JOIN
    “CUSTDATA”.“STORE” “STORE”
    ON
    (“INDIVIDUAL_DEMOGRAPHICS”.“PREFERRED_STORE_ID” =
“STORE”.“STORE_ID”)
    WHERE
    (“STORE”.“REGION_ID” = 1)
    )
  ) seg
  JOIN
  (
  SELECT
    “TRANS”.“HOUSEHOLD_ID”,
    “TRANS”.“CATEGORY_CD”,
    period.st_dt,
    period.dt_desc
  FROM
    (
SELECT
  *
FROM
  “CUSTDATA”.“TRANS” “TRANS”
WHERE
  (“TRANS”.“PURCHASE_AMT” >= 5) AND
  (“TRANS”.“PURCHASE_DT” BETWEEN ‘01/01/1996’ (DATE, FORMAT
‘MM/DD/YYYY’) AND
                ‘12/31/1997’ (DATE, FORMAT ‘MM/DD/YYYY’))
    ) trans,
    TDEV510.ios_prd period
  WHERE
    period.div_id = 1 and
    period.freq_lev_cd = ‘Y’ and
    TRANS.PURCHASE_DT <= period.end_dt and /* this PURCHASE_DT
can also be, for example, POLICY_ST_DT */
    TRANS.PURCHASE_DT >= period.st_dt  /* this PURCHASE_DT can
also be, for example, POLICY_END_DT */
  GROUP BY
    “TRANS”.“HOUSEHOLD_ID”,
    “TRANS”.“CATEGORY_CD”,
    period.st_dt,
    period.dt_desc
  ) t
  ON
  (seg.HOUSEHOLD_ID = t.HOUSEHOLD_ID)
  LEFT OUTER JOIN
  (
  SELECT
    “TRANS”.“HOUSEHOLD_ID”,
    “TRANS”.“CATEGORY_CD”,
    period.st_dt,
    period.dt_desc,
    Count(Distinct Trim(“TRANS”.“HOUSEHOLD_ID”) || ‘-’ ||
            Trim(“TRANS”.“CATEGORY_CD”) || ‘-’ ||
            Trim(period.dt_desc)) tot_customers,
    Sum(“TRANS”.“ITEM_QTY”)  tot_items,
    SUM(“TRANS”.“PURCHASE_AMT”)  tot_dollars,
    MAX(“TRANS”.“ITEM_QTY”)  MAX_ITEM_QTY2
  FROM
    (
    SELECT
    “TRANS”.“HOUSEHOLD_ID”,
    “TRANS”.“CATEGORY_CD”,
    “TRANS”.“PURCHASE_DT”,
    “TRANS”.“ITEM_QTY”,
    “TRANS”.“PURCHASE_AMT”
    FROM
    “CUSTDATA”.“TRANS” “TRANS”
    WHERE
    (
    HOUSEHOLD_ID, INDIVIDUAL_ID, ACCOUNT_TYPE_CD,
ACCOUNT_ID, STORE_ID, DMA_ID, REGION_ID, PURCHASE_DT,
DEPT_ID, PURCHASE_AMT,
    TRANS_NBR, TRANS_TYPE_CD, ITEM_QTY, CLASS_ID,
VENDOR_ID, DIVISION_ID, ITEM_ID, ITEM_COLOR_ID, ITEM_SIZE_ID,
    SALES_ASSOC_ID, CATEGORY_CD, GROUP_CD,
BSKT_ITEM_QTY, BSKT_DISTINCT_QTY, BSKT_PURCHASE_AMT
    ) IN
    (
    SELECT
      HOUSEHOLD_ID, INDIVIDUAL_ID, ACCOUNT_TYPE_CD,
ACCOUNT_ID, STORE_ID, DMA_ID, REGION_ID, PURCHASE_DT,
DEPT_ID, PURCHASE_AMT,
      TRANS_NBR, TRANS_TYPE_CD, ITEM_QTY, CLASS_ID,
VENDOR_ID, DIVISION_ID, ITEM_ID, ITEM_COLOR_ID, ITEM_SIZE_ID,
      SALES_ASSOC_ID, CATEGORY_CD, GROUP_CD,
BSKT_ITEM_QTY, BSKT_DISTINCT_QTY, BSKT_PURCHASE_AMT
    FROM
      (
      SELECT
      *
      FROM
      “CUSTDATA”.“TRANS” “TRANS”
      WHERE
      (“TRANS”.“PURCHASE_AMT” >= 5) AND
      (“TRANS”.“PURCHASE_DT” BETWEEN ‘01/01/1996’ (DATE,
FORMAT ‘MM/DD/YYYY’) AND
                      ‘12/31/1997’ (DATE, FORMAT ‘MM/DD/YYYY’))
      ) trans
    )
    ) trans,
    TDEV510.ios_prd period
  WHERE
    period.div_id = 1 and
    period.freq_lev_cd = ‘Y’ and
    TRANS.PURCHASE_DT <= period.end_dt and /* this PURCHASE_DT
can also be, for example, POLICY_ST_DT */
    TRANS.PURCHASE_DT >= period.st_dt  /* this PURCHASE_DT can
also be, for example, POLICY_END_DT */
  GROUP BY
    “TRANS”.“HOUSEHOLD_ID”,
    “TRANS”.“CATEGORY_CD”,
    period.st_dt,
    period.dt_desc
  ) measure
  ON
  (
  t.HOUSEHOLD_ID = measure.HOUSEHOLD_ID and
  t.CATEGORY_CD = measure.CATEGORY_CD and
  t.st_dt = measure.st_dt and
  t.dt_desc = measure.dt_desc
  )
  LEFT OUTER JOIN
  (
  SELECT
    “TRANS”.“HOUSEHOLD_ID”,
    “TRANS”.“CATEGORY_CD”,
    period.st_dt,
    period.dt_desc,
    AVG(“TRANS”.“PURCHASE_AMT” /
“TRANS”.“GROSS_PURCHASE_AMT”)
AVG_TRANS_SPEND_PRODUCT
  FROM
    (
    SELECT
    “YEAR_HH_X_DEPT_SUMMARY”.“HOUSEHOLD_ID”,
    “YEAR_HH_X_DEPT_SUMMARY”.“CATEGORY_CD”,
    “YEAR_HH_X_DEPT_SUMMARY”.“YEAR_START_DT”,
    “YEAR_HH_X_DEPT_SUMMARY”.“LAST_PURCHASE_DT”,
    “TRANS”.“PURCHASE_DT”,
    “TRANS”.“PURCHASE_AMT”,
    “YEAR_HH_X_DEPT_SUMMARY”.“GROSS_PURCHASE_AMT”
    FROM
    “CUSTDATA”.“YEAR_HH_X_DEPT_SUMMARY”
“YEAR_HH_X_DEPT_SUMMARY”
    JOIN
    “CUSTDATA”.“TRANS” “TRANS”
    ON
    (“YEAR_HH_X_DEPT_SUMMARY”.“HOUSEHOLD_ID” =
“TRANS”.“HOUSEHOLD_ID”) AND
    (“YEAR_HH_X_DEPT_SUMMARY”.“CATEGORY_CD” =
“TRANS”.“CATEGORY_CD”) AND
    (“YEAR_HH_X_DEPT_SUMMARY”.“GROUP_CD” =
“TRANS”.“GROUP_CD”) AND
    (“YEAR_HH_X_DEPT_SUMMARY”.“DEPT_ID” =
“TRANS”.“DEPT_ID”) and
    (“YEAR_HH_X_DEPT_SUMMARY”.“YEAR_START_DT” <=
“TRANS”.“PURCHASE_DT”) and
    (“YEAR_HH_X_DEPT_SUMMARY”.“LAST_PURCHASE_DT” >=
“TRANS”.“PURCHASE_DT”)
    WHERE
    (“YEAR_HH_X_DEPT_SUMMARY”.“GROSS_PURCHASE_AMT” >=
10) and
    (“TRANS”.“PURCHASE_DT” between ‘04/01/1996’ (date, format
‘MM/DD/YYYY’) and
                    ‘06/30/1996’ (date, format ‘MM/DD/YYYY’)) and
    (
    trans.HOUSEHOLD_ID trans.INDIVIDUAL_ID,
trans.ACCOUNT_TYPE_CD, trans.ACCOUNT_ID, trans.STORE_ID,
trans.DMA_ID,
    trans.REGION_ID, trans.PURCHASE_DT, trans.DEPT_ID,
trans.PURCHASE_AMT, trans.TRANS_NBR, trans.TRANS_TYPE_CD,
trans.ITEM_QTY,
    trans.CLASS_ID, trans.VENDOR_ID, trans.DIVISION_ID,
trans.ITEM_ID, trans.ITEM_COLOR_ID, trans.ITEM_SIZE_ID,
    trans.SALES_ASSOC_ID, trans.CATEGORY_CD, trans.GROUP_CD,
trans.BSKT_ITEM_QTY, trans.BSKT_DISTINCT_QTY,
    trans.BSKT_PURCHASE_AMT
    ) IN
    (
    SELECT
      HOUSEHOLD_ID, INDIVIDUAL_ID, ACCOUNT_TYPE_CD,
ACCOUNT_ID, STORE_ID, DMA_ID, REGION_ID, PURCHASE_DT,
DEPT_ID, PURCHASE_AMT,
      TRANS_NBR, TRANS_TYPE_CD, ITEM_QTY, CLASS_ID,
VENDOR_ID, DIVISION_ID, ITEM_ID, ITEM_COLOR_ID, ITEM_SIZE_ID,
      SALES_ASSOC_ID, CATEGORY_CD, GROUP_CD,
BSKT_ITEM_QTY, BSKT_DISTINCT_QTY, BSKT_PURCHASE_AMT
    FROM
      (
      SELECT
      *
      FROM
      “CUSTDATA”.“TRANS” “TRANS”
      WHERE
      (“TRANS”.“PURCHASE_AMT” >= 5) AND
      (“TRANS”.“PURCHASE_DT” BETWEEN ‘01/01/1996’ (DATE,
FORMAT ‘MM/DD/YYYY’) AND
                      ‘12/31/1997’ (DATE, FORMAT ‘MM/DD/YYYY’))
      ) trans
    WHERE
      trans.purchase_dt between
“YEAR_HH_X_DEPT_SUMMARY”.“YEAR_START_DT” and
“YEAR_HH_X_DEPT_SUMMARY”.“LAST_PURCHASE_DT”
    )
    ) trans,
    TDEV510.ios_prd period
  WHERE
    period.div_id = 1 and
    period.freq_lev_cd = ‘Y’ and
    TRANS.PURCHASE_DT <= period.end_dt and /* this PURCHASE_DT
can also be, for example, POLICY_ST_DT */
    TRANS.PURCHASE_DT >= period.st_dt and  /* this PURCHASE_DT
can also be, for example, POLICY_END_DT */
    TRANS.YEAR_START_DT <= period.end_dt and
    TRANS.LAST_PURCHASE_DT >= period.st_dt
  GROUP BY
    “TRANS”.“HOUSEHOLD_ID”,
    “TRANS”.“CATEGORY_CD”,
    period.st_dt,
    period.dt_desc
  ) measure_multitable_1
  ON
  (
  t.HOUSEHOLD_ID = measure_multitable_1.HOUSEHOLD_ID and
  t.CATEGORY_CD = measure_multitable_1.CATEGORY_CD and
  t.st_dt = measure_multitable_1.st_dt and
  t.dt_desc = measure_multitable_1.dt_desc
  )
  group by
  t.st_dt,
  t.dt_desc,
  t.CATEGORY_CD
  ) t
JOIN
  CUSTDATA.CATEGORY p
ON
  t.CATEGORY_CD = p.CATEGORY_CD
```

4) Product Affinity Analysis, Regular, Targeting

Query Form:

```
SELECT
  <Semantic Key>, ...  // semantic keys as specified in the profile,
not the product level
FROM
  [<Table>]  // sub-select. this is the sub-select for the segment.
optional.
[JOIN]
  (
  SELECT
  <Semantic Key>, ...  // semantic keys as specified in the profile
(e.g., Category and Household).
  FROM
  <Table>  // temp table from step 0 above.
  GROUP BY
  <Semantic Key>, ...  // semantic keys as specified in the profile
(e.g., Category and Household).
  ) mainTable
[
ON
  <joins on semantic level> // semantic level of the analysis, not the
product level (e.g., Household only).
]
JOIN
  (
  SELECT
  <Semantic Key>, ...  // semantic keys as specified in the
profile (e.g., Category and Household).
  FROM
  <Table>, ...  // table(s) where this measure is sourced
from (measure table).
  WHERE
  <Condition>, ...  // condition(s) such as date range and/or
filter of the measure.
  (<Complete Joins>) IN
  (
  SELECT
    <Complete Joins>
  FROM
    <Table>  // temp table from step 0 above.
  [
  JOIN
    <Table>, ...  // link table(s) that are needed for the join
between measure table and temp table.
  ON
    <Joins>
  ]
  [
  WHERE
    <Non-Equi Joins>  // non-equi joins to complete the join
between measure table and temp/link table.
  ]
  )
  GROUP BY
  <Semantic Key>, ...  // semantic keys as specified in the
profile (e.g., Category and Household).
  ) measure
ON
  <joins on semantic level>  // semantic level of the analysis,
AND the product level (e.g., Household and Category).
WHERE
  <Condition>, ...  // targeting conditions
GROUP BY
  <Semantic Key>, ...  // semantic keys as specified in the profile,
not the product level
```

Example sql:

```
select
  t.HOUSEHOLD_ID
from
  (
  SELECT
  “HOUSEHOLD_ACTIVITY_SUMMARY”.“HOUSEHOLD_ID”
  FROM
  “CUSTDATA”.“HOUSEHOLD_ACTIVITY_SUMMARY”
“HOUSEHOLD_ACTIVITY_SUMMARY”
  WHERE
  (
  “HOUSEHOLD_ACTIVITY_SUMMARY”.“HOUSEHOLD_ID”
  ) IN
  (
  SELECT
    “INDIVIDUAL_DEMOGRAPHICS”.“HOUSEHOLD_ID”
  FROM
    “CUSTDATA”.“INDIVIDUAL_DEMOGRAPHICS”
“INDIVIDUAL_DEMOGRAPHICS”
  JOIN
    “CUSTDATA”.“STORE” “STORE”
  ON
    (“INDIVIDUAL_DEMOGRAPHICS”.“PREFERRED_STORE_ID”
    =
“STORE”.“STORE_ID”)
  WHERE
    (“STORE”.“REGION_ID” = 1)
  )
  ) seg // segment sub-select
JOIN
  (
  SELECT
  “TRANS”.“HOUSEHOLD_ID”,
  “TRANS”.“CATEGORY_CD”
  FROM
  TempTable  // temp table from step 0 above.
  GROUP BY
  “TRANS”.“HOUSEHOLD_ID”,
  “TRANS”.“CATEGORY_CD”
  ) t // filter sub-select (main table)
ON
  (seg.HOUSEHOLD_ID = t.HOUSEHOLD_ID)
JOIN
  (
  SELECT
  “TRANS”.“HOUSEHOLD_ID”,
  “TRANS”.“CATEGORY_CD”
  FROM
  “CUSTDATA”.“YEAR_HH_X_DEPT_SUMMARY”
“YEAR_HH_X_DEPT_SUMMARY”
  JOIN
  “CUSTDATA”.“TRANS” “TRANS”
  ON
  (“YEAR_HH_X_DEPT_SUMMARY”.“HOUSEHOLD_ID” =
“TRANS”.“HOUSEHOLD_ID”) AND
  (“YEAR_HH_X_DEPT_SUMMARY”.“CATEGORY_CD” =
“TRANS”.“CATEGORY_CD”) AND
  (“YEAR_HH_X_DEPT_SUMMARY”.“GROUP_CD” =
“TRANS”.“GROUP_CD”) AND
  (“YEAR_HH_X_DEPT_SUMMARY”.“DEPT_ID” =
  “TRANS”.“DEPT_ID”)
and
  (“YEAR_HH_X_DEPT_SUMMARY”.“YEAR_START_DT” <=
“TRANS”.“PURCHASE_DT”) and
  (“YEAR_HH_X_DEPT_SUMMARY”.“LAST_PURCHASE_DT”
  >=
“TRANS”.“PURCHASE_DT”)
  WHERE
  (“YEAR_HH_X_DEPT_SUMMARY”.-
  “GROSS_PURCHASE_AMT” >= 10)
and
  (“TRANS”.“PURCHASE_DT” between ‘04/01/1996’ (date, format
‘MM/DD/YYYY’) and
                  ‘06/30/1996’ (date, format ‘MM/DD/YYYY’)) and
  (<Complete Joins>) IN
  (
  SELECT
    <Complete Joins>
  FROM
    TempTable  // temp table from step 0 above.
  WHERE
    TempTable.purchase_dt between
“YEAR_HH_X_DEPT_SUMMARY”.“YEAR_START_DT” and
“YEAR_HH_X_DEPT_SUMMARY”.“LAST_PURCHASE_DT”
  )
  GROUP BY
  “TRANS”.“HOUSEHOLD_ID”,
  “TRANS”.“CATEGORY_CD”
  ) measure_multitable_1 // measure sub-select
ON
  (
  t.HOUSEHOLD_ID = measure_multitable_1.HOUSEHOLD_ID and
  t.CATEGORY_CD = measure_multitable_1.CATEGORY_CD
  )
where
  (t.CATEGORY_CD = ‘FRN’) or // targeting conditions
  (t.CATEGORY_CD = ‘HOM’)
group by
  t.HOUSEHOLD_ID
```

5) Product Affinity Analysis, Regular Affinity, Targeting

Query Form:

```
SELECT
  <Semantic Key>, ...  // semantic keys as specified in the
profile, not the product level
FROM
  [<Table>]  // sub-select. this is the sub-select for the
segment. optional.
[JOIN]
  (
  SELECT
  DISTINCT <Semantic Key>, ... // semantic level of the analysis, not the
product level (e.g., Household only).
  FROM
  <Table>  // main table of the analysis
  WHERE
  <Condition>, ...  // condition(s) such as date range and/or
filter of the analysis.
  <affinity product selections> // product(s) affinitied on
  )
[
ON
  <joins on semantic level>  // semantic level of the analysis, not the
product level (e.g., Household only).
]
JOIN
  (
  SELECT
  <Semantic Key>, ...  // semantic keys as specified in the profile
(e.g., Category and Household).
  FROM
  <Table>  // temp table from step 0 above.
  GROUP BY
  <Semantic Key>, ...  // semantic keys as specified in the profile
(e.g., Category and Household).
  ) mainTable
ON
  <joins on semantic level>  // semantic level of the analysis, not the
product level (e.g., Household only).
JOIN
  (
  SELECT
  <Semantic Key>, ...  // semantic keys as specified in
the profile (e.g., Category and Household).
  FROM
  <Table>, ...  // table(s) where this measure is sourced
from (measure table).
  WHERE
  <Condition>, ...  // condition(s) such as date range
and/or filter of the measure.
  (<Complete Joins>) IN
  (
  SELECT
    <Complete Joins>
  FROM
    <Table>  // temp table from step 0 above.
  [
  JOIN
    <Table>, ...  // link table(s) that are needed for the join
between measure table and temp table.
  ON
    <Joins>
  ]
  [
  WHERE
    <Non-Equi Joins>  // non-equi joins to complete the join
between measure table and temp/link table.
  ]
  )
  GROUP BY
  <Semantic Key>, ...  // semantic keys as specified in the
profile (e.g., Category and Household).
  ) measure
ON
  <joins on semantic level>  // semantic level of the analysis,
AND the product level (e.g., Household and Category).
WHERE
  <Condition>, ...  // targeting conditions
GROUP BY
  <Semantic Key>, ...  // semantic keys as specified in the
profile, not the product level
```

Example sql:

```
select
  t.HOUSEHOLD_ID
from
  (
  SELECT
  “HOUSEHOLD_ACTIVITY_SUMMARY”.“HOUSEHOLD_ID”
  FROM
  “CUSTDATA”.“HOUSEHOLD_ACTIVITY_SUMMARY”
“HOUSEHOLD_ACTIVITY_SUMMARY”
  WHERE
  (
  “HOUSEHOLD_ACTIVITY_SUMMARY”.“HOUSEHOLD_ID”
  ) IN
  (
  SELECT
    “INDIVIDUAL_DEMOGRAPHICS”.“HOUSEHOLD_ID”
  FROM
    “CUSTDATA”.“INDIVIDUAL_DEMOGRAPHICS”
“INDIVIDUAL_DEMOGRAPHICS”
  JOIN
    “CUSTDATA”.“STORE” “STORE”
  ON
    (“INDIVIDUAL_DEMOGRAPHICS”.“PREFERRED_STORE_ID” =
“STORE”.“STORE_ID”)
  WHERE
    (“STORE”.“REGION_ID” = 1)
  )
  ) seg // segment sub-select
JOIN
  (
  select
  Distinct t.HOUSEHOLD_ID
  from
  CUSTDATA.trans t
  where
  (t.PURCHASE_AMT >= 5) AND  // filter of the
analysis
  (t.PURCHASE_DT between ‘01/01/1996’ (date, format ‘MM/DD/YYYY’)
AND  // date range of the analysis
                ‘12/31/1997’ (date, format ‘MM/DD/YYYY’)) AND
  (“TRANS”.“CATEGORY_CD”) in  // product(s)
affinitied on
  (
  SELECT
    “CATEGORY”.“CATEGORY_CD”
  FROM
    “CUSTDATA”.“CATEGORY” “CATEGORY”
  WHERE
    (“CATEGORY”.“CATEGORY_CD” = ‘ACC’)
  )
  ) p
ON
  (seg.HOUSEHOLD_ID = p.HOUSEHOLD_ID)
JOIN
  (
  SELECT
  “TRANS”.“HOUSEHOLD_ID”,
  “TRANS”.“CATEGORY_CD”
  FROM
  TempTable  // temp table from step 0 above.
  GROUP BY
  “TRANS”.“HOUSEHOLD_ID”,
  “TRANS”.“CATEGORY_CD”
  ) t
ON
  (
  seg.HOUSEHOLD_ID = t.HOUSEHOLD_ID and
  p.HOUSEHOLD_ID = t.HOUSEHOLD_ID
  )
JOIN
  (
  SELECT
  “TRANS”.“HOUSEHOLD_ID”,
  “TRANS”.“CATEGORY_CD”
  FROM
  “CUSTDATA”.“YEAR_HH_X_DEPT_SUMMARY”
“YEAR_HH_X_DEPT_SUMMARY”
  JOIN
  “CUSTDATA”.“TRANS” “TRANS”
  ON
  (“YEAR_HH_X_DEPT_SUMMARY”.“HOUSEHOLD_ID” =
“TRANS”.“HOUSEHOLD_ID”) AND
  (“YEAR_HH_X_DEPT_SUMMARY”.“CATEGORY_CD” =
“TRANS”.“CATEGORY_CD”) AND
  (“YEAR_HH_X_DEPT_SUMMARY”.“GROUP_CD” =
“TRANS”.“GROUP_CD”) AND
  (“YEAR_HH_X_DEPT_SUMMARY”.“DEPT_ID” = “TRANS”.“DEPT_ID”)
and
  (“YEAR_HH_X_DEPT_SUMMARY”.“YEAR_START_DT” <=
“TRANS”.“PURCHASE_DT”) and
  (“YEAR_HH_X_DEPT_SUMMARY”.“LAST_PURCHASE_DT” >=
“TRANS”.“PURCHASE_DT”
  WHERE
  (“YEAR_HH_X_DEPT_SUMMARY”.“GROSS_PURCHASE_AMT” >= 10)
and
  (“TRANS”.“PURCHASE_DT” between ‘04/01/1996’ (date, format
‘MM/DD/YYYY’) and
                ‘06/30/1996’ (date, format ‘MM/DD/YYYY’)) and
  (<Complete Joins>) IN
  (
  SELECT
    <Complete Joins>
  FROM
    TempTable  // temp table from step 0 above.
  WHERE
    TempTable.purchase_dt between
“YEAR_HH_X_DEPT_SUMMARY”.“YEAR_START_DT” and
“YEAR_HH_X_DEPT_SUMMARY”.“LAST_PURCHASE_DT”
  )
  GROUP BY
  “TRANS”.“HOUSEHOLD_ID”,
  “TRANS”.“CATEGORY_CD”
  ) measure_multitable_1
ON
  (
  t.HOUSEHOLD_ID = measure_multitable_1.HOUSEHOLD_ID and
  t.CATEGORY_CD = measure_multitable_1.CATEGORY_CD
  )
where
  (t.CATEGORY_CD = ‘FRN’) or // targeting conditions
  (t.CATEGORY_CD = ‘HOM’)
group by
  t.HOUSEHOLD_ID
                  © Teradata, Inc. 2009
```

One now fully appreciates the improved techniques for Product Affinity Analysis presented herein and above. Some of these benefits include, but are not limited to:

Firstly, the criteria for a Product Affinity Analysis chart can now be saved as a profile and reused without having to manually re-enter criteria.

Secondly, the SQL, which calculates the results, is now dynamically generated rather than statically defined at installation. In addition to being a much more flexible architecture, this also allows customers to benefit automatically from any SQL optimizations done at an administrative level. This means Information Technology (IT) personnel no longer have to spend time manually tweaking their own custom SQL to gain performance enhancements, since the queries are now generated automatically.

Thirdly, users can now define custom measures or reuse existing measures rather than having a fixed predefined list of measures at installation. Again, a measure is a reusable aggregate calculation, such as “Average Purchase Amount,” “Number of customers who bought this product,” or “Total Items Sold.”

Lastly, users can potentially plot other pairs of schemas besides customers vs. products, expanding the types of business questions which can be answered. Again, a schema defines relationship between entities stored in a company's data warehouse (customers, products, services, stores, transactions, trips, flights, hotels, suppliers, etc.). With the techniques presented herein, a schema can now represent many-to-many relationships between entities.

In sum, the techniques presented herein for Product Affinity Analysis provide a variety of improvements over conventional Product Affinity Analysis products and tools.

The Product Affinity Analysis techniques presented herein provide an improved user-interface where a user can enter criteria such as schema, custom measures, filter, date range, universe segment, and run schedule. The software described herein and executed on processor(s) dynamically generates the SQL and processes the calculations offline against an enterprise's data warehouse. In some embodiments, when a job is finished, an e-mail notification is sent so the user can click on a link and view his/her results in a chart or grid. Then, using a simple drop-down menu from the toolbar, the user can drill up or down to different hierarchical levels of products or services to examine purchasing behavior or affinities in a particular category. The user can even select portions of the bar chart or grid and save the selections as a targeted segment which can be used in communications, segment plans, or other analysis.

For instance, a bar chart can calculate how many people purchased items in the Electronics, Furniture, Clothing, and Jewelry categories. By drilling down into Electronics, a user can see the breakdown for the number of people who bought TVs, VCRs, DVD players, and cell phones. Drilling down further will show the user how many people bought cell phones by brand. The user can create a targeted segment of these people, or do an affinity analysis (e.g. “of people who bought cell phones, what else did they buy?”). Product Affinity Analysis enables the user to answer important business questions such as, and by example only:
Which products are most commonly purchased together?
What combination of products is most often purchased by a segment?
What future items will likely be purchased by a customer who buys a certain product or service?
Which banking services and offers are more profitable?
Which stores contain the most/least inventory?
Which hotels and vacation packages are preferred by people who flew on a certain airline?

So, the improved techniques for Product Affinity Analysis allow marketing analysts to easily customize their charts without having to understand SQL or contact their IT staff or support personnel. They can save and reuse their analysis profile criteria, making them more productive. Using custom measures, many-to-many relationships, and diverse schemas, they can answer many new business questions that were never before possible.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method implemented in a computer-readable storage medium and executed on a processing device, the method comprising:
interacting, via the processing device, with a user to gather criteria for a Product Affinity Analysis chart;
recording, via the processing device, the criteria for current use in generating the Product Affinity Analysis chart and for future use in subsequently generating the Product Affinity Analysis chart or derivations thereof; and
dynamically and automatically generating, via the processing device, Structure Query Language (SQL) code that when processed against a data store produces results to populate the Product Affinity Analysis chart.

2. The method of claim 1, wherein interacting further includes interacting with the user via a Graphical User Interface (GUI) tool that includes user-guided fields to receive from the user different portions of the criteria.

3. The method of claim 1, wherein interacting further includes receiving from the user as a portion of the criteria a custom measure defined by the user.

4. The method of claim 1, wherein interacting further includes presenting to the user a selection of re-usable and existing measures, one or more of which the user selects as a portion of the criteria.

5. The method of claim 1, wherein interacting further includes receiving as a portion of the criteria custom multiple schemas to plot the results against within the Product Affinity Analysis chart.

6. The method of claim 5, wherein receiving further includes identifying at least one of the multiple schemas as representing many-to-many relationships between entities in the data store.

7. The method of claim 1, wherein recording further includes storing the criteria as a re-usable profile of the user.

8. A method implemented in a computer-readable storage medium and executed by a processor, the method comprising:
presenting, via the processor, an interface to a user for receiving criteria that define parameters for defining a Product Affinity Analysis chart;
receiving, by the processor, from the user different portions of the criteria in defined fields of the interface;
automatically and dynamically producing, by the processor, software that when executed retrieves data from a data warehouse that was defined by the criteria, wherein the data represents results from searching the data warehouse via executing the software; and
populating, by the processor an instance of the Product Affinity Analysis chart in a display for viewing by the user.

9. The method of claim 8, wherein presenting further includes displaying the interface as an interactive Graphical User Interface (GUI) tool that the user interacts with to supply the criteria.

10. The method of claim 8, wherein receiving further includes mapping the fields to predefined types of conditions associated with the criteria.

11. The method of claim 8, wherein automatically and dynamically producing further includes generating the software as a Structured Query Language (SQL) search query having filters and measures.

12. The method of claim 8, wherein populating further includes presenting the Product Affinity Analysis chart as an interactive chart that the user can interact with.

13. The method of claim 12, wherein presenting the Product Affinity Analysis chart further includes populating increased detail in the Product Affinity Analysis chart in response to a user interaction with the Product Affinity Analysis chart.

14. The method of claim 12, wherein presenting the Product Affinity Analysis chart further includes populating decreased detail in the Product Affinity Analysis chart in response to a user interaction with the Product Affinity Analysis chart.

15. A processor-implemented system comprising:
an affinity analysis service implemented in a computer-readable storage medium and to execute on a processor; and
a data warehouse that is a storage device and is accessible to the affinity analysis service via the processor;
wherein the affinity analysis service interacts with a user to gather user-defined criteria and to generate Structured Query Language (SQL) code from the criteria that when processed against the data warehouse produces a Product Affinity Analysis chart.

16. The system of claim 15, wherein the Product Affinity Analysis chart is interactive.

17. The system of claim 15, wherein the affinity analysis service is to present a Graphical User Interface (GUI) tool to the user for supplying the user-defined criteria.

18. The system of claim 17, wherein the GUI tool includes predefined fields for receiving predefined types of conditions associated with the user-defined criteria.

19. The system of claim 15, wherein affinity analysis service is to save the user-defined criteria as a profile for the user to re-use.

20. The system of claim 15, wherein the data warehouse is a collection of relational databases interfaced together.
